(19) United States
(12) Patent Application Publication
(10) Pub. No.: US 2013/0097061 A1
(43) Pub. Date: Apr. 18, 2013

(54) SYSTEM, METHOD AND APPARATUS FOR DYNAMICALLY GENERATING A QUESTION FLOW

(71) Applicant: The Royal Bank of Scotland plc, Edinburgh (GB)

(72) Inventors: Martin Saich, Edinburgh (GB); Paul Hemming, Edinburgh (GB); Stephen Malvern, Edinburgh (GB)

(73) Assignee: THE ROYAL BANK OF SCOTLAND PLC, Edinburgh (GB)

(21) Appl. No.: 13/649,473

(22) Filed: Oct. 11, 2012

(30) Foreign Application Priority Data
Oct. 12, 2011 (GB) 1117603.9

(51) Int. Cl. G06Q 40/00

(52) U.S. Cl. 705/35

(57) ABSTRACT

A decisioning system and method for dynamically building a question flow for determining a financial product suitable for a customer. The method includes selecting a second data capture stage from a predetermined set of one or more possible second data capture stages on the basis of an eligibility score associated with a financial product. The eligibility score is based on customer information submitted in response to a first data capture stage and is updated on the basis of customer information submitted in response to the selected second data capture stage. The first data capture stage and the second data capture stage each comprise data relating to one or more questions to be presented to a user.

### CROSS REFERENCE TO RELATED APPLICATIONS

This Application claims priority to United Kingdom Patent Application No. 1117603.9 filed Oct. 12, 2011, the contents of which are incorporated herein in its entirety.

### TECHNICAL FIELD

The present disclosure relates to methods and apparatus for dynamically generating a question flow for determining a financial product suitable for a customer.

### BACKGROUND

Financial institutions, such as banks, building societies and insurance providers, provide advice to customers in relation to appropriate financial products or services. The financial products provided by financial institutions include credit products (e.g. loans, mortgages, credit cards) and investment products (e.g. bonds, stocks, foreign exchange). Advice in relation to these products may be provided in response to a customer enquiry (e.g. a loan or mortgage application) or a routine review of a customer's personal and financial circumstances. The financial advice provided by the financial institution will typically relate to one or more recommended products or services which are deemed suitable for the customer's needs, and the advice must conform to applicable laws and regulations (e.g. Financial Services and Markets Act 2000 in the United Kingdom). Such laws and regulations are designed to ensure the competence of providers of financial services and protect the interests of their customers.

As the number and complexity of financial products have increased, it has become increasingly difficult for customers to determine which products are most suited to their needs. Thus, financial advice is normally provided by qualified financial advisors who are versed in the available products, the relevant financial regulations and the needs of the customer, thereby enabling them to provide regulated advice which is appropriate for the customer.

One drawback of providing advice through a financial advisor is that remuneration is often determined on a commission basis. This introduces a potential conflict of interest which, in turn, may result in a customer being provided with incorrect advice (e.g. an inappropriate product recommendation). Similarly, providing advice in this manner incurs additional expense which is typically reflected in the cost of the financial advice and the financial products.

More recently, attempts have been made automate the process of providing financial advice (e.g. through a Web site or suitable software). Automation of the advising process ensures that financial products and services can be recommended to the customer without bias and in a consistent fashion. However, it has proven difficult to develop an automated process which balances the needs of the customer and the interests of the financial institution within a regulated framework. Thus, existing automated processes are typically restricted to a single product class, such as mortgages, and are generally only appropriate for customers with a certain level of financial knowledge. In ether words, online services of this nature have been unable to replicate the holistic services which are provided by a qualified financial advisor.

### SUMMARY

In accordance with one aspect there is provided a computer-implemented method of dynamically building a question flow for determining a financial product suitable for a customer, the method comprising: selecting a second data capture stage from a predetermined set of one or more possible second data capture stages on the basis of an eligibility score associated with a financial product, the eligibility score being based on customer information submitted in response to a first data capture stage; and updating the eligibility score on the basis of customer information submitted in response to the selected second data capture stage; wherein, the first data capture stage and the second data capture stage each comprise data relating to one or more questions to be presented to a user.

According to some embodiments, the eligibility score is based on a risk score indicating the credit risk associated with the respective financial product.

According to some embodiments, the method further comprises updating the risk score on the basis of customer information submitted in response to the second data capture stage.

According to some embodiments, the eligibility score is based on an affordability score indicating the allowability of the respective financial product.

According to some embodiments, the method further comprises updating the affordability score on the basis of customer information submitted in response to the second data capture stage.

According to some embodiments, the eligibility score is based on an propensity score indicating the propensity of the customer towards the respective financial product.

According to some embodiments, the method further comprises updating the propensity score on the basis of customer information submitted in response to the second data capture stage.

According to some embodiments, the predetermined set of one or more possible second data capture stages is defined by link data associated with the first data capture stage.

According to some embodiments, the link data associated with the first data capture stage provides one or more conditional associations between the eligibility score and the one or more possible second data capture stages.

According to some embodiments, said selecting a second data capture stage is performed on the basis of a plurality of eligibility scores associated with a plurality of respective financial products.

According to some embodiments, the predetermined set of one or more possible second data capture stages is defined by link data associated with the first data capture stage.

According to some embodiments, the link data associated with the first data capture stage provides one or more conditional associations between the plurality of eligibility scores and the one or more possible second data capture stages.

According to some embodiments, the method further comprises terminating the question flow if said plurality of eligibility scores satisfy an offering condition.

According to some embodiments, said offering condition specifies a predetermined threshold level and the question flow is terminated when one of more of the eligibility scores exceeds the predetermined threshold level.

According to some embodiments, said offering condition specifies a predetermined threshold level and the question flow is terminated when a predetermined number of the eligibility scores each exceed the predetermined threshold level.

In accordance with another aspect there is provided a decisioning system for dynamically building a question flow for determining a financial product suitable for a customer, the decisioning system comprising a processor configured to: select a second data capture stage from a predetermined set of one or more possible second data capture stages on the basis of an eligibility score associated with a financial product, the eligibility score being based on customer information submitted in response to a first data capture stage, and update the eligibility score on the basis of customer information submitted in response to the second data capture stage; wherein the first data capture stage and the second data capture stage each comprise data relating to one or more questions to be presented to a user.

According to some embodiments, the eligibility score is based on a risk score indicating the credit risk associated with the respective financial product.

According to some embodiments, the process if further configured to update the risk score on the basis of customer information submitted in response to the second data capture stage.

According to some embodiments, the eligibility score is based on an affordability score indicating the affordability of the respective financial product.

According to some embodiments, the processor is further configured to update the affordability score on the basis of customer information submitted in response to the second data capture stage.

According to some embodiments, the eligibility score is based on a propensity score indicating the propensity of the customer towards the respective financial product.

According to some embodiments, the processor is further configured to update the propensity score on the basis of customer information submitted in response to the second data capture stage.

According to some embodiments, the predetermined set of one or more possible second data capture stages is defined by link data associated with the first data capture stage.

According to some embodiments, the link data associated with the first data capture stage provides one or more conditional associations between the eligibility score and the one or more possible second data capture stages.

According to some embodiments, the processor is configured to select the second data capture stage on the basis of a plurality of eligibility scores associated with a plurality of respective financial products.

According to some embodiments, the predetermined set of one or more possible second data capture stages is defined by link data associated with the first data capture stage.

According to some embodiments, the link data associated with the first data capture stage provides one or more conditional associations between the plurality of eligibility scores and the one or more possible second data capture stages.

According to some embodiments, the processor is further configured to terminate the question flow if said plurality of eligibility scores satisfies an offering condition.

According to some embodiments, said offering condition specifies a predetermined threshold level and the question flow is terminated when one of more of the eligibility scores exceeds the predetermined threshold level.

According to some embodiments, said offering condition specifies a predetermined threshold level and the question flow is terminated when a predetermined number of the eligibility scores each exceed the predetermined threshold level.

In accordance with another aspect, there is provided a computer program product comprising a non-transitory computer-readable storage medium having computer-readable instructions stored thereon, the computer-readable instructions being executable by a computerized device to cause the computerized device to perform a method of dynamically building a question flow for determining a financial product suitable for a customer, the method comprising: selecting a second data capture stage from a predetermined set of one or more possible second data capture stages on the basis of an eligibility score associated with a financial product, the eligibility score being based on customer information submitted in response to a first data capture stage, and updating the eligibility score on the basis of customer information submitted in response to the second data capture stage; wherein the first data capture stage and the second data capture stage each comprise data relating to one or more questions to be presented to a user.

In accordance with another aspect, there is provided a computer-implemented method of dynamically building a question flow for determining a financial product suitable for a customer, the method comprising: selecting data representing a second data capture stage from data representing a predetermined set of one or more possible second data capture stages, said selection being performed on the basis of data representing an eligibility score associated with a financial product, the eligibility score being based on data received in response to a first data capture stage; generating a graphical user interface representing the second data capture stage on the basis of the selected data representing the second data capture stage; and recalculating the eligibility score on the basis of data received via the graphical user interface in response to the second data capture stage.

Further features and advantages of the disclosure will become apparent from the following description of preferred embodiments of the disclosure given by way of example only, which is made with reference to the accompanying drawings.

### BRIEF DESCRIPTION OF THE DRAWINGS

FIG. 1 is a schematic diagram of a portal system for dynamically building a question flow in accordance with an embodiment of the disclosure.

FIG. 2 is flow diagram showing a method of dynamically building a question flow in accordance with an embodiment of the disclosure.

FIGS. 3A and 3B are schematic diagrams of a data capture module and a product module for use in dynamically building a question flow in accordance with an embodiment of the disclosure.

FIGS. 4A and 4B are flow diagrams showing a method of dynamically building a question flow in accordance with an embodiment of the disclosure.

FIGS. 5A and 5B are schematic diagrams of a graphical user interface generated in accordance with an embodiment of the disclosure.

### DETAILED DESCRIPTION

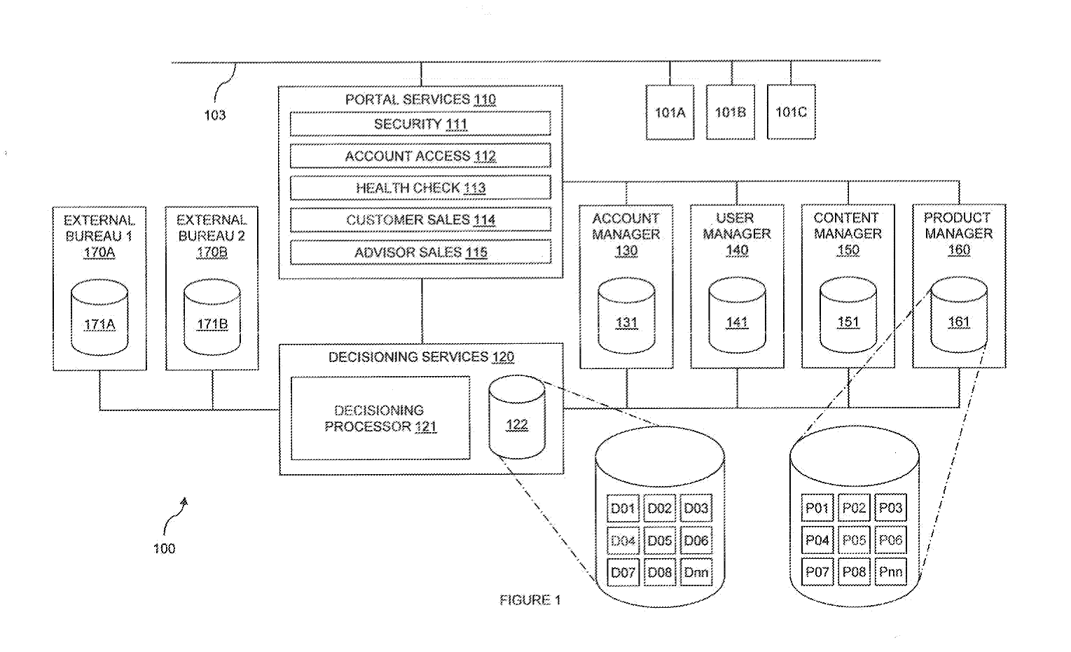

FIG. 1 shows the functional components of an exemplary portal system 100 for a financial institution in accordance with an embodiment of the disclosure. The portal system 100 provides a Web portal, through which users are able to access appropriate financial advice from the financial institution in an automated manner (e.g. recommendations in relation to one or more financial products). Typically, the user is a customer of the financial institution or a financial advisor providing advice on behalf of the financial institution.

The portal system 100 is communicatively connected to a network 103 (e.g. the Internet) and is accessible by a user using a client software application running on a network enabled device 101A-C. Examples of suitable network enabled devices include personal computers, laptop computers, mobile telephones, personal digital assistants (PDAs), network enabled televisions, tablet devices, or any other device capable of sending and receiving data over the network 103. Typically, the client software application is a Web browser running on the network enabled device and the user accesses the products and services provided by the Web portal by directing the Web browser to an associated address (e.g. http://www.rbs.com/portal). In alternative embodiments, the client software application may be embodied as a dedicated banking application which is configured to interface with the Web portal and provide the user with access to the various products and services (e.g. a dedicated mobile app).

Access to the portal system 100 and its associated services is controlled by a portal services component 110, which is supported by a plurality of ancillary components, including an account manager component 130, a user manager component 140, a content manager component 150 and a product manager component 160. The ancillary components provide common portal functionality which is utilised by the portal system 100 to respond to user actions and requests. For example, the account manager component 130 manages access to user account information stored in an account database 131. Similarly, the user manager component 140 manages access to user information stored in a user database 141. The content manager component 150 manages a content database 151 which stores the content required to generate one or more Web pages for the Web portal (e.g. images, scripts, content etc.). The product manager component 160 manages access to data relating to a plurality of financial products stored in a product database 161 in the form of product modules Pnn.

The portal services component 110 includes a security service 111 which is responsible for authenticating users prior to granting them access to sensitive or confidential information held by the portal system 100 (e.g. account information stored in account database 131). Authentication may be achieved using conventional methods such as a user ID and password, a security token such as the SecurID™ token produced by RSA™, or multi-factor authentication techniques as are known in the art. Authentication data associated with the users and utilised by the security service 111 is managed by the user manager component 140. The security service 111 also provides a secure channel over which data can be exchanged with a user's network enabled device 101A-C, using conventional methods such as Hypertext Transfer Protocol Secure (HTTPS).

Users who have been authenticated by the security service 111 are provided with access their account information, managed by the account manager component 130, using an account access service 112. The account access service 112 typically enables an authenticated user to view their account balance, make fund transfers and set up standing orders etc.

The portal system 100 provides a health check service 113, through which a user is able to receive an assessment of their financial health by providing information relating to their personal circumstances, future plans, current financial situation and attitudes towards risk etc. On the basis of the information provided by the user, the health cheek service 113 provides the user with appropriate financial advice (e.g. one or more financial product recommendations). Preferably the advice provided by the health check service 113 should satisfy any applicable financial regulations, such as those set out in Financial Services and Markets Act 2000 in the United Kingdom.

Similarly, the portal system 100 also provides a customer sales service 114 which enables customers to access advice relating to financial products suitable for their particular needs (e.g. loans, mortgages, investments). The customer provides information relating to their personal circumstances, future plans, current financial situation and attitudes towards risk etc, on the basis of which the customer sales service 114 determines appropriate financial advice relating to one or more financial product recommendations. Again, it is preferable that the advice should satisfy applicable financial regulations.

In some embodiments, the portal system 100 also provides an advisor sales service 115 which enables financial advisors to access advice relating to financial products appropriate for the needs of a customer. In such embodiments, the advisor sales service 115 provides relevant customer information in the manner of the customer sales service 114, on the basis of which the advisor sales service 115 determines appropriate financial advice for the customer. Some embodiments provide the advisor with access to financial products which are not normally available to an unassisted customer for regulatory reasons. Further embodiments may permit the advisor to override recommendations from the portal system, within regulator bounds and with appropriate justification.

It order to provide appropriate advice, the health check service 113, the customer sales service 114 and the advisor sales service 115 require the user to provide relevant information relating to the customer. This is achieved by means of a plurality of data capture stages which together form a question flow designed to solicit the required customer information from the user. Typically, each data capture stage comprises one or more questions which are presented to the user as a Web page. For example, a first data capture stage may comprise questions relating to the customer's sources of income, whereas a second data capture stage may comprise questions relating to the customer's existing credit commitments (e.g. credit card balances, student loans etc.). The questions typically require answers in multiple choice, short answer or numerical format, although it will be appreciated that a wide variety of questions are possible and answers may be provided in any suitable means. Thus, the term “question” as used herein is intended to encompass any means by which customer information is captured in a data capture stage, without restriction to any particular form or method.

Preferably, selection of the various data capture stages forming the question flow is performed by a decisioning services component 120 which provides a single consolidated decisioning service for the health check service 113, the customer sales service 114 and the advisor sales service 115. The decisioning services component 120 comprises a decisioning processor 121 and a module database 122, which stores data relating to a plurality of data capture modules Dnn. The decisioning services component 120 is communicatively connected the portal services component 110, the account manager component 130, the user manager component 140, the content manager component 150 and the product manager component 160. The decisioning services component 120 is further operable to communicate with one or more external bureau systems 170A, 170B, comprising databases 171A and 171B respectively, to retrieve one or more external resources when required. Typically, the external bureau systems 170A and 170B manage information relating to the credit worthiness of customers in the form of a credit score or similar (e.g. Experian™ Limited of the United Kingdom).

The decisioning services component 120 is configured to dynamically select appropriate data capture stages to form a question flow. Selection of the data capture stage may be performed in accordance with the nature of the user (e.g. customer or advisor), the context within which the advice is to be provided (e.g. a financial health check or customer sales or advisor sales), and in response to previously captured customer information. More specifically, the decisioning services component 120 dynamically generates the question flows using the plurality of data capture modules stored in module database 122. The composition of the question flow is determined at least partly on the basis of one or more metrics associated with the products Pnn. The metrics are calculated on the basis of customer information captured as the user progresses through the question flow, and optionally one or more internal resources (e.g. customer account information or transaction history) and/or one or more external resources (e.g. customer credit scores retrieved from external bureaus 170A and 170B).

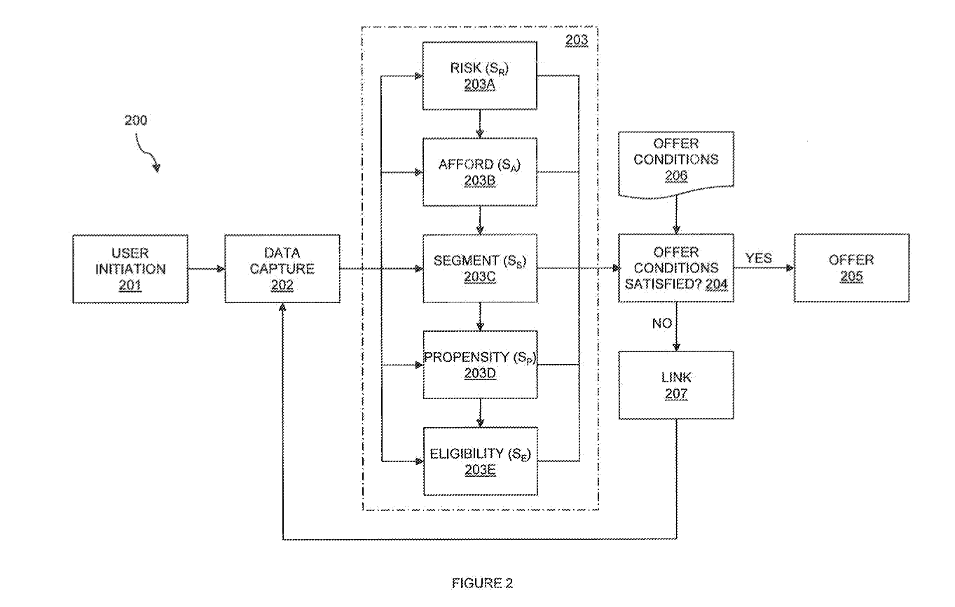

Selection of the data capture stages forming the question flow is now described in more detail, with reference to FIG. 2, which shows an embodiment of a computer-implemented method 200 performed by the decisioning services component 120 of FIG. 1. The method 200 is initiated when a user accesses the health check service 113, the customer sales service 114, or the advisor sales service 115 (step 201). First, the decisioning service component 120 executes a first data capture phase (step 202), according to which decisioning service component presents the user with one or more questions in the form of a Web page. The first data capture stage may be predetermined by the type of service accessed by the user (i.e. the health check service 113, the customer sales service 114 or the advisor sales service 115), such that a customer accessing the health cheek service 113 may be presented with a different data capture stage than would be the case if an advisor accessed the advisor sales service 115. In either case, the user provides customer information in response to presented questions, and the decisioning services component 120 uses the customer information to calculate or recalculate one or more metrics (step 203) for each of the plurality of financial products Pnn stored in product database 161.

More specifically, the plurality of metrics associated with each product may include a product risk score S_{R} (step 203A), a product affordability score S_{A} (step 203B), a customer segmentation metric S_{S} (step 203C) and a product propensity score S_{P} (step 203D). In combination, these metrics contribute to an overall product eligibility score S_{E} (step 203E) which provides a measure of the eligibility or suitability of the respective product fox the customer in question.

The product risk score S_{R} provides a measure of the credit risk posed to the financial institution if the associated product is provided to the customer. The product risk score S_{R} is typically an integer value in the range 0 to 100, where a score of S_{R}=0 represent zero risk and S_{R}=100 represents an unacceptably high risk. The product risk score may be calculated using any suitable technique known in the art and will typically utilise the customer information captured during the data capture stage (step 202) and one or more external and internal resources (e.g. a credit score associated with the customer and obtained from external bureau 170A).

The product affordability score S_{A} provides a measure of the affordability of the associated product for the customer in question. The affordability score S_{A} is calculated on the basis of internal resources stored in the account database 131 (e.g. account balance history) and customer information obtained during the data capture stage (step 202). Again, the product affordability score S_{A} is typically an integer score in the range 0 to 100, where a score of S_{A}=0 indicates that the associated product is unaffordable and a score of S_{A}=100 indicates that the associated product is affordable.

The customer segmentation metric S_{S} provides an indication as to which of a plurality of customer segments the customer may be classified. In this context, a customer segment is a sub-set of the financial institution's customer base, and unites customers with similar characteristics (e.g. age, income, spending habits, attitude to risk etc.). The customer segmentation S_{S} is generally a code which indicates the customer segment associated with the customer in question. Segmentation is performed on the basis of internal resources such as account information stored in the account database 131 (e.g. account transaction history), customer information obtained during the data capture stage (step 202) or a previously determined segmentation (e.g. through conventional “Know Your Customer” (KYC) procedures). Generally, the customer segmentation S_{S} is independent of any particular product, and instead reflects characteristics associated with the customer.

The product propensity score S_{P} indicates the customer's propensity to buy the associated product. The product propensity score S_{P} is calculated on the basis of internal resources such as account information stored in the account database 131 (e.g. transaction history indicating products and services purchased by the customer) and information obtained during the data capture stage (step 202). Again, the product propensity score S_{P} is typically an integer score in the range 0 to 100, where a score of S_{P}=0 indicates that the customer is highly unlikely to purchase the associated product, and a score of S_{P}=100 indicates that the customer is highly likely to purchase the associated product.

The product eligibility score S_{E} indicates the relative suitability of the associated product for the customer in question. Generally, the product eligibility score S_{E} is expressed as an integer score in the range 0 to 100, where a score of S_{E}=0 indicates that the product is highly inappropriate for the customer, and a score of S_{E}=100 indicates that the product is highly appropriate for the customer. In preferred embodiments, the product eligibility score S_{E} is calculated on the basis of the other metrics, namely the product risk score S_{R}, the product affordability score S_{A}, the customer segmentation S_{S}, and the product propensity score S_{P}. Prior to commencement of the question flow, each of the metrics is initiated on the basis of available information associated with the customer, such as account balance.

Once the various metrics have been calculated for each of the plurality of products, the decisioning services component 120 determines whether one or more offer conditions 206 have been satisfied by the calculated metrics (step 204). The offer conditions 206 specify a set of thresholds which must be satisfied by the calculated metrics prior to providing advice to the user (e.g. a recommendation of one or more financial products). For example, the offer conditions 206 may specify that at least two products with a product eligibility score S_{E} greater or equal to 70 must be determined before those products are presented to the user as recommended products (step 205). Alternatively, the offer conditions 206 may be more sophisticated and, for example, specify that only products with a product eligibility score S_{E} greater or equal to 70 and a risk score less than or equal to 30 can be recommended to the user (step 205). In a further embodiment, each product may be associated with its own offer conditions.

It will be appreciated that in some circumstances none of the available products may be appropriate for the customer in question. The offer conditions 206 can account for this by specifying thresholds, below which the question flow is terminated without making a product recommendation. For example, the offer conditions may specify that if the risk score associated with any of the product exceeds 60, the question flow is terminated without making a product recommendation.

If the one or more offer conditions 206 are not satisfied (i.e. the decisioning services component 120 is not able to provide appropriate advice on the basis of the captured customer information), the question flow is continued and the decisioning processor 121 determines the next data capture phase to link to in order to obtain additional customer information from the user (step 207). This link step results in further data capture from the user (step 202), recalculation of the one or more metrics (step 203) and further determination as to whether the offer conditions 206 have been satisfied (step 204). In this manner, steps 202, 203, 204 & 207 provide an iterative loop, through which suitable products or advice for the customer can be identified. Provision of the link stage (step 207) ensures that the question flow is dynamically generated in response to the calculated metrics (step 203) and ensures that only relevant information is obtained via the data capture stage (step 202).

If, after a predetermined number of loops no offer conditions have been satisfied (i.e. no suitable products have been determined), the process is stopped and a default advice message is shown to the user (e.g. “No appropriate products found. Please contact your local branch for further advice”). Thus, the method ensures that only those products which are suitable for the customer and present an acceptable credit risk to the financial institution are presented to the user. In other words, the method arbitrates between the needs of the customer and the needs of the financial institution.

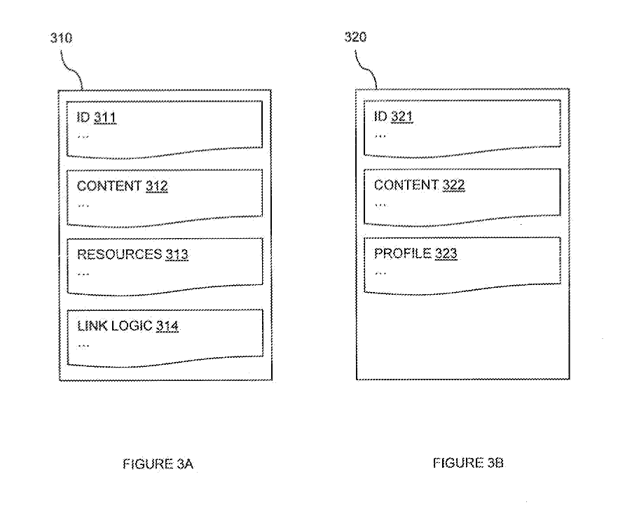

The computer-implemented method 200 of FIG. 2 is embodied in the one or more data capture modules Dnn stored in the module database 122. Each of the data capture modules Dnn is a self contained section of question How and implements a respective data capture stage (step 202). With reference to FIG. 3A, an embodiment of a data capture module 310 includes a module identifier 311, content data 312, resource data 313 and link data 314. The content data 312 relates to the questions to be presented to the user for the data capture module in question, and typically specifies the format by which the question should be presented to the user by reference to content managed by the content manager component 150. The link data 314 defines a set of one or more linkable data capture stages and logic specifying the respective link conditions. The resource data 313 specifies one or more internal and external resources that are required by the logic specified in the link data 314. Typically, the link data 314 takes the form of a script comprising a plurality of logical operations associated with the captured customer information, the calculated metrics, and any internal or external resources that may have been retrieved in accordance with the resource data 313.

With reference to FIG. 3B, an embodiment of a product module 320 comprises a product identifier 321 and content data 322. The content data 322 includes information relating to the product in question (e.g. a loan or mortgage) and would typically include a product description and product terms and conditions. The content data 322 may further specify the format by which the question should be presented to the user by reference to content managed by the content manager component 150. The product module also includes profile data 323 which provides a characterisation of the associated financial product and is used by the decisioning processor 121 to calculate the various metrics. In some embodiments, the profile data 323 includes threshold data which specifies the offer conditions for the respective financial product. The products may also be grouped by type (e.g. credit cards, loans, investments) and further grouped by customer segmentation.

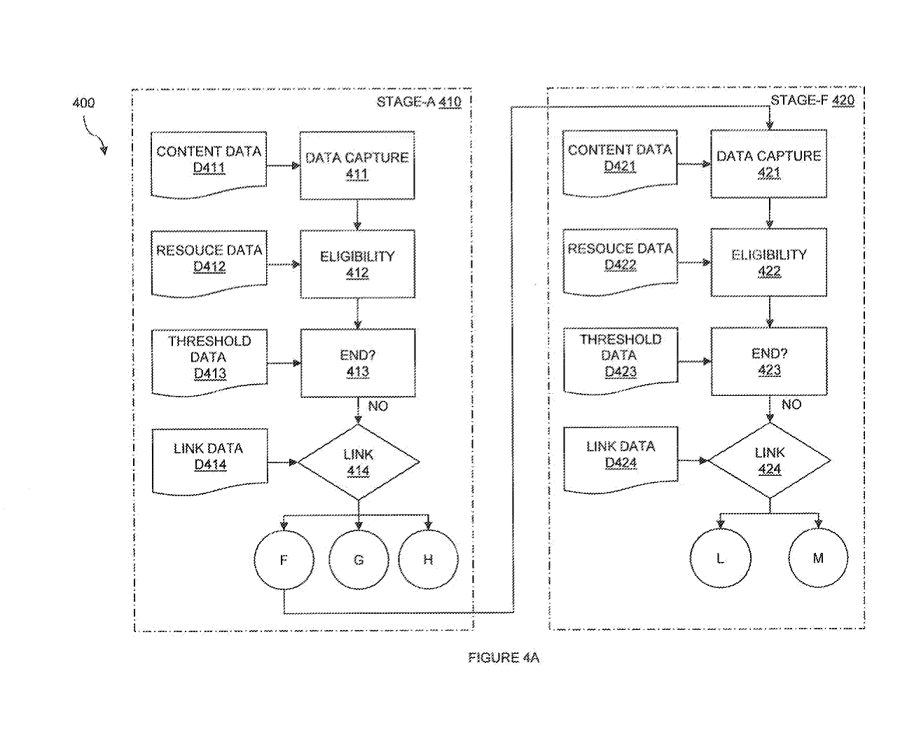

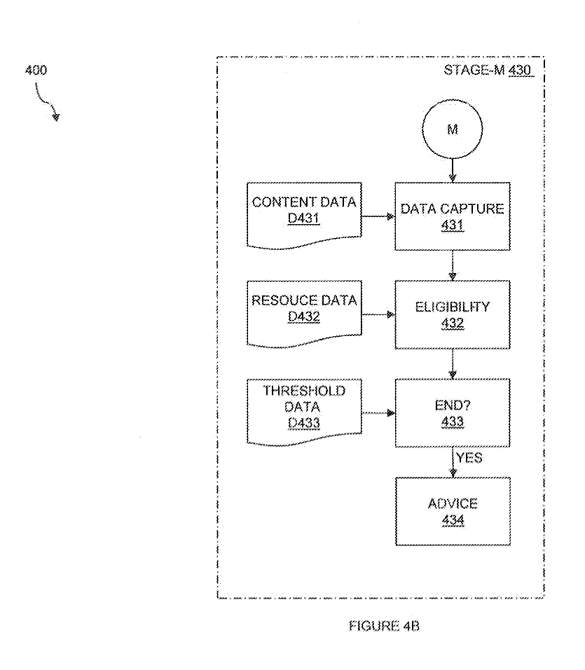

FIGS. 4A and 4B shows a method performed by an embodiment of the decisioning services component 120 when dynamically generating a question flow in accordance with an embodiment of the disclosure. The method results in a question flow 400 comprising a first data capture stage 410 (STAGE-A) associated with a first data capture module, a second data capture stage 420 (STAGE-F) associated with a second data capture module, and a third data capture stage 430 (STAGE-M) associated with a third data capture module.

In the first data capture stage, the decisioning service component 120 uses the content data D411 stored in the first data capture module to generate a first Web page including the first question or questions in the question flow (step 411). Next, in response to customer information provided by the user via the first Web page, the decisioning services component 120 retrieves one or more resources, as specified by the resource data D412 stored in first data capture module, and recalculates each product eligibility score S_{E} on the basis of the customer information and retrieved resources (step 412). Once the eligibility scores S_{E} have been calculated, the decisioning services component 120 determines whether the offer conditions specified by threshold data D413 for each product have been satisfied (step 413). In the present embodiment no offer conditions have been met and the decisioning services component 120 proceeds to determine the next data capture stage to link to on the basis of link data D414 in the first data capture module (step 414). In the present example, the link data specifies three possible data capture stages for linking (STAGE-F, STAGE-G and STAGE-B). On the basis of the calculated metrics and retrieved resources, the decisioning services component 120 selects and links to the second data capture stage 420 (STAGE-F).

The second data capture stage follows a similar course to that of the first data capture stage. First, the decisioning services component 120 uses the content data D421 stored in the second data capture module to generate a second Web page including the second question or questions in the question flow (step 421). Next in response to customer information provided by the user via the second Web page, the decisioning services component 120 retrieves one or more resources as specified by the resource data D422 stored in second data capture module and recalculates each product eligibility score S_{E} on the basis of the customer information and retrieved resources (step 422). Once the eligibility scores S_{E} have been calculated, the decisioning services component 120 determines that the conditions specified by threshold data D423 have not been satisfied (step 423) and thus determines the next data capture stage to link to on the basis of link data D424 stored in the second data capture module (step 424). In this case, the link dais associated with the second data capture module specifies two possible data capture stages for linking (STAGE-L and STAGE-M), and, on the basis of the calculated metrics and retrieved resources, the decisioning services component 120 selects and links to the third data capture stage 430 (STAGE-M).

Again, the third data capture stage, follows a similar course to that of the first and second data capture stages. First, the decisioning services component 120 uses the content data D431 stored in the third data capture module to generate a third Web page including the third question or questions in the question flow (step 431). Next, in response to customer information provided by the user via the third Web page, the decisioning services component 120 retrieves one or more resources as specified by the resource data D432 stored in third data capture module and recalculates each product eligibility score S_{E} on the basis of the customer information and relieved resources (step 432). Once the eligibility scores S_{E} have been calculated, the decisioning service component 120 determines that the offer conditions specified by threshold data D433 have been satisfied in respect of one or more products (step 433) and proceeds to recommend those products to the user (step 434).

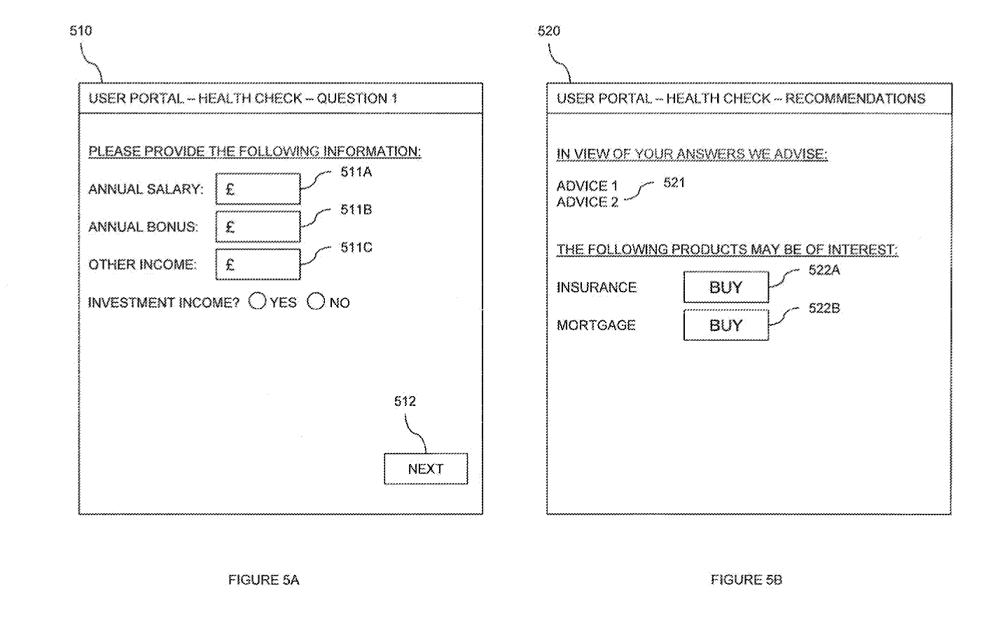

FIG. 5A shows an exemplary data capture stage in the form of a Web page 510 generated in accordance with an embodiment of the disclosure. The Web page 510 comprises a plurality of questions 511A-C relating to the customer's sources of income. The user inputs appropriate answers to the questions and clicks the “next” button 512, at which point the decisioning services component 120 determines whether the thresholds have been satisfied and, if appropriate, determines the next data capture stage to link to.

FIG. 5B shows an exemplary advice Web page 520 in accordance with an embodiment of the disclosure. The Web page 520 includes content relating to advice 521 and content relating to products appropriate for the customer with options to purchase 522A and 522B.

It will be appreciated that embodiments of the disclosure provide arbitration between the needs of the customer and the risk to the financial institution. Thus, embodiments of the disclosure are particularly suitable for providing advice in relation to regulated products where there exists a burden of proof of fairness and compliance with the relevant regulations. Furthermore, embodiments of the disclosure serve to mitigate “conduct risk” by providing means to ensure a repeatable and consistent distribution of financial product offers and advice to customers, with transparent and balanced decision making in each and every customer interaction across multiple banking distribution channels.

In further embodiments, computer code for performing all or part of the methods described above may be provided as a computer program product comprising a non-transitory computer-readable storage medium, such as a CD-ROM or FLASH memory. The non-transitory storage medium typically stores a plurality of computer readable instructions which, when executed by a computer, cause the computer to perform all or part of the methods described above with reference to the figures.

The above embodiments are to be understood as illustrative examples of the disclosure. Further embodiments of the disclosure are envisaged. For example, further metrics may be utilised in the decisioning process to account characteristics such as customer health or future earning potential. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A computer-implemented method of dynamically building a question flow for determining a financial product suitable for a customer, the method comprising:
selecting a second data capture stage from a predetermined set of one or more possible second data capture stages on the basis of an eligibility score associated with a financial product, the eligibility score being based on customer information submitted in response to a first data capture stage; and
updating the eligibility score on the basis of customer information submitted in response to the selected second data capture stage;
wherein, the first data capture stage and the second data capture stage each comprise data relating to one or more questions to be presented to a user.

2. A computer-implemented method according to claim 1, wherein the eligibility score is based on a risk score indicating the credit risk associated with the respective financial product.

3. A computer-implemented method according to claim 2, further comprising updating the risk score on the basis of customer information submitted in response to the second data capture stage.

4. A computer-implemented method according to claim 1, wherein the eligibility score is based on an affordability score indicating the affordability of the respective financial product.

5. A computer-implemented method according to claim 4, further comprising updating the affordability score on the basis of customer information submitted in response to the second data capture stage.

6. A computer-implemented method according to claim 1, wherein the eligibility score is based on an propensity score indicating the propensity of the customer towards the respective financial product.

7. A computer-implemented method according to claim 6, further comprising updating the propensity score on the basis of customer information submitted in response to the second data capture stage.

8. A computer-implemented method according to claim 1, wherein the predetermined set of one or more possible second data capture stages is defined by link data associated with the first data capture stage.

9. A computer-implemented method according to claim 8, wherein the link data associated with the first data capture stage provides one or more conditional associations between the eligibility score and the one or more possible second data capture stages.

10. A computer-implemented method according to claim 1, wherein said selecting a second data capture stage is performed on the basis of a plurality of eligibility scores associated with a plurality of respective financial products.

11. A computer-implemented method according to claim 10, wherein the predetermined set of one or more possible second data capture stages is defined by link data associated with the first data capture stage.

12. A computer-implemented method according to claim 11, wherein the link data associated with the first data capture stage provides one or more conditional associations between the plurality of eligibility scores and the one or more possible second data capture stages.

13. A computer-implemented method according to claim 10, further comprising terminating the question flow if said plurality of eligibility scores satisfy an offering condition.

14. A computer-implemented method according to claim 13, wherein said offering condition specifies a predetermined threshold level and the question flow is terminated when one of more of the eligibility scores exceeds the predetermined threshold level.

15. A computer-implemented method according to claim 13, wherein said offering condition specifies a predetermined threshold level and the question flow is terminated when a predetermined number of the eligibility scores each exceed the predetermined threshold level.

16. A decisioning system for dynamically building a question flow for determining a financial product suitable for a customer, the decisioning system comprising a processor configured to:
select a second data capture stage from a predetermined set of one or more possible second data capture stages on the basis of an eligibility score associated with a financial product, the eligibility score being based on customer information submitted in response to a first data capture stage; and
update the eligibility score on the basis of customer information submitted in response to the second data capture stage;
wherein the first data capture stage and the second data capture stage each comprise data relating to one or more questions to be presented to a user.

17. A decisioning system according to claim 16, wherein the eligibility score is based on a risk score indicating the credit risk associated with the respective financial product.

18. A decisioning system according to claim 17, wherein the process if further configured to update the risk score on the basis of customer information submitted in response to the second data capture stage.

19. A computer program product comprising a non-transitory computer-readable storage medium having computer-readable instructions stored thereon, the computer-readable instructions being executable by a computerized device to cause the computerized device to perform a method of dynamically building a question flow for determining a financial product suitable for a customer, the method comprising:
selecting a second data capture stage from a predetermined set of one or more possible second data capture stages on the basis of an eligibility score associated with a financial product, the eligibility score being based on customer information submitted in response to a first data capture stage; and
updating the eligibility score on the basis of customer information submitted in response to the second data capture stage;
wherein the first data capture stage and the second data capture stage each comprise data relating to one or more questions to be presented to a user.

20. A computer-implemented method of dynamically building a question flow for determining a financial product suitable for a customer, the method comprising:
selecting data representing a second data capture stage from data representing a predetermined set of one or more possible second data capture stages, said selection being performed on the basis of data representing an eligibility score associated with a financial product, the eligibility score being based on data received in response to a first data capture stage;
generating a graphical user interface representing the second data capture stage on the basis of the selected data representing the second data capture stage; and
recalculating the eligibility score on the basis of data received via the graphical user interface in response to the second data capture stage.
